(19) United States
(12) Patent Application Publication
(10) Pub. No.: US 2006/0007518 A1
(43) Pub. Date: Jan. 12, 2006

(54) Electrochromic display with analog intrinsic full color pixels

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Kininklijke Philips Electronics N.V., Eindhoven (NL)

(21) Appl. No.: 10/524,405

(22) PCT Filed: Jul. 2, 2003
(86) PCT No.: PCT/IB03/02973

§ 371 Date: Feb. 11, 2005

(30) Foreign Application Priority Data
Aug. 15, 2002 (EP) 02078379.1

(51) Int. Cl. G02F 1/15

(52) U.S. Cl. 359/265

(57) ABSTRACT

A display device comprising a plurality of independently addressable pixels (1). Each pixel comprises: a first substrate (6); a second substrate (7); a polyelectrochromic material (2) disposed between said first substrate (6)and said second substrate (7). At least two independent electrodes (3, 4) are associated with said first substrate (6). An independent counter-electrode (5) is associated with said second substrate (7). Each respective electrode is connected to an independently controllable voltage source. The display device has means for controlling the voltage applied to each respective electrode (3, 4, 5) for producing non-uniform electric fields in each pixel (1), for causing partial switching of the polyelectrochromic material (2) from a first color state to a second color state to generate an area ratio defined pixel color state.

### FIELD OF THE INVENTION

The present patent application relates to the field of electrochromic display devices, and particularly to a method and apparatus for providing full color to such display devices. More specifically, the present patent application relates to an efficient system for providing analog intrinsic full color to electrochromic display devices. The present patent application also relates to a computer program product comprising software code portions for achieving the system and method for providing analog intrinsic full color to electrochromic display appliances when said product is run on a computer.

### BACKGROUND OF THE INVENTION

Recently electrochromic display devices have been studied as candidates for electronic paper type displays. However, the slow switching speed and high power consumption of the electrochromic display technologies commercially available today do not meet the needs of the display market. Lately the trend for improving performance has been towards the use of nano-materials, such as chemically modified nano-structured mesophorous films. Use of such materials has shown promising results. However, one of the remaining key issues with respect to electrochromic displays is the generation of color.

One prior art approach to providing a multicolor electrochromic display suggests to achieve more than two colors in a display cell through the use of a range of voltages applied between a display side electrode and a counter electrode, providing for a change of color of the display cell. A system of this type is disclosed in U.S. Pat. No. 4,371,236.

### SUMMARY OF THE INVENTION

Accordingly, it is an object of the present invention to provide an improved apparatus for providing full color to an electrochromic display appliance.

This object is achieved by the apparatus according to the invention as specified in claim 1.

A further object of the invention is to provide an improved method for providing full color to an electrochromic display appliance.

This object is achieved by the method according to the invention as claimed in claim 7.

Yet another object of the invention is to provide an improved computer program product comprising software code portions for achieving the apparatus and method for providing full color to an electrochromic display appliance when said product is run on a computer.

This object is achieved by the computer program product according to the invention as specified in claim 10.

Further advantageous embodiments of the invention are specified in the dependent claims.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should further be understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote like elements throughout the several views:

FIG. 1 discloses a schematic cross sectional view of a pixel of a display device according to a first embodiment of the invention with electric field lines shown;

FIG. 2 discloses a schematic cross sectional view of the pixel of FIG. 1 with the entire polyelectrochromic layer in a first color;

FIG. 3 discloses a schematic cross section of the pixel of FIG. 1 with a centrally located part of the polyelectrochromic layer in a second color and the rim portions in a first color;

FIG. 4 discloses a schematic cross section of the pixel of FIG. 1 with a large portion of the polyelectrochromic layer in a first color and a smaller portion in a second color;

FIG. 5 discloses a schematic cross section of the pixel of FIG. 1 with approximately half the polyelectrochromic layer in a first color and half in a second color;

FIG. 6 discloses a schematic cross section of the pixel of FIG. 1 with a small portion of the polyelectrochromic layer in a first color and the larger portion in a second color;

FIG. 7 discloses a schematic cross section of the pixel of FIG. 1 with the polyelectrochromic layer wholly in a second color; and

FIG. 8 discloses a schematic cross section of the pixel of FIG. 1 with the polyelectrochromic layer divided into three portions, respectively in a first, second and third color.

### DETAILED DESCRIPTION OF THE PRESENTLY PREFERRED EMBODIMENTS

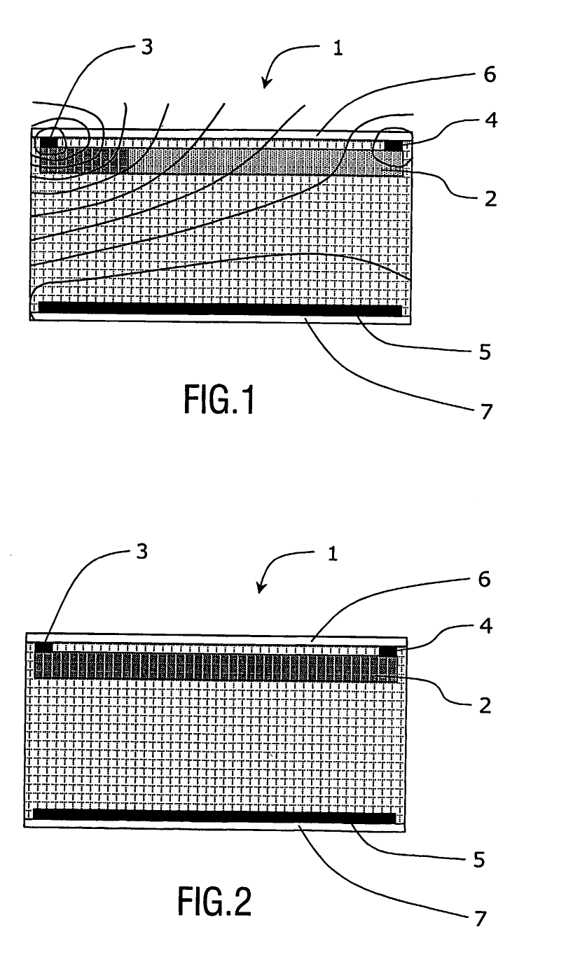

FIG. 1 shows a schematic cross sectional view of a pixel 1 of an electrochromic display according to a first embodiment. Each pixel of the electrochromic display is independently addressable and can be separated from each other either electrically or physically, in order to avoid cross-talk between pixels. The pixel 1 comprises: a first substrate 6, which is preferably transparent and made of a material such as a glass or from a plastic plate; a second substrate 7, which in some cases, such as for a back lit display, can also be transparent; a polyelectrochromic material 2 disposed between said first substrate 6 and said second substrate 7; at least two independent conductive electrodes 3, 4 associated with said first substrate 6, which electrodes 3, 4 are preferably transparent; an independent conductive counter-electrode 5 associated with said second substrate 7. The pixel 1 also comprises a transparent electrolytic material in contact with said polyelectrochromic material 2 and said counter-electrode 5. The polyelectrochromic material is an electrochromic solution which, depending upon the oxidation state, can generate primary colors, such as RGB (red, green, blue) or CMY (cyan, magenta, yellow). Several polyelectrochromic materials are known to the person skilled in the art to have such characteristics. Each respective electrode 3, 4, 5 is connected to an independently controllable voltage source (not shown). The display device comprises means (not shown) for controlling the voltage applied to each respective electrode 3, 4, 5, such as an electronic display control device which can comprise a micro-processor. In this way, using the display control device, non-uniform electric fields can be produced in each pixel, e.g. as illustrated in FIG. 1 where electric field lines are shown for a case where a voltage of approximately 2V is applied to the electrode 3, while 0V is applied to electrode 4 and counter-electrode 5. These non-uniform electric fields will cause partial switching of the polyelectrochromic material 2 from a first color state to a second color state (illustrated in the figures by the different gray level regions of the polyelectrochromic material 2). Due to the non-uniform field distribution, the charge flow will initially be concentrated on a region close to the positively charged electrode 3. As a consequence, this region will switch first, and the pixel 1 will be generated with part of its polyelectrochromic material 2 in a first color and part in another color. Provided that the applied voltage is sufficiently high if further charge is allowed to pass through the region closer to the positively charged electrode, a further change to another third color could be envisaged. The region which changes color is defined by the lateral distribution of the charging electrons, being determined by the field distribution. In this manner, many color shades, such as e.g. pink, can be generated in the pixel 1. The color generated in this way will be defined by the integral amount of charge passing into the polyelectrochromic material 2 and hence by the time in which the electrodes 3, 4, 5 of the pixel 1 are connected to their respective voltage sources. Application of a still higher voltage or use of a still longer time period may cause the polyelectrochromic material 2 to change to a further color state. The time required to switch to a desired state for the preferred type of display is less than 1 second. Erasure, i.e. reset, can easily be achieved through making a change of polarities. Such a reset can be used to define a reference state form which all possible gray levels can be generated. If no reset is used, it will be necessary to remember the previous state of the pixel before supplying the correct amount of charge (or discharge) to reach a new color state. In such a case the electronic display control device will comprise memory storage means (not shown), where the previous color state generated is stored and the new color state to be achieved is compared with the previous color state and the required charge (discharge) to be applied in order to reach the desired color state is determined.

FIG. 2 illustrates the pixel 1 when 0V is applied to the electrodes 3 and 4, while a negative potential is applied to the counter-electrode 5 for a long period of time. In this case the pixel 1 will be generated with all its polyelectrochromic material 2 in a first color. This state could be used as a reset state.

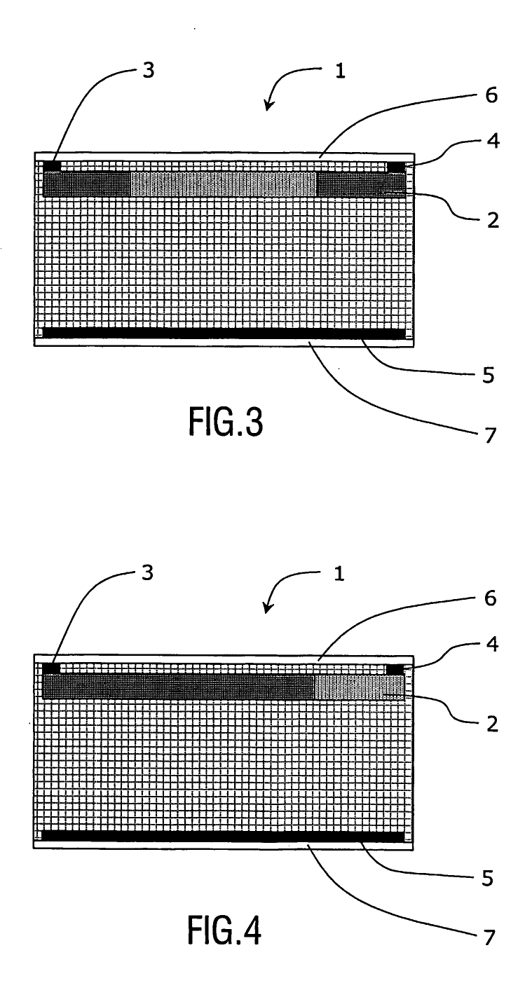

FIG. 3 illustrates the pixel 1 when moderate positive potentials are applied to the electrodes 3 and 4 for a given period of time, while 0V is applied to the counter-electrode 5. In this case the pixel 1 will be generated with the regions of its polyelectrochromic material 2 close to the positively charged electrodes 3 and 4 in the first color and the part of its polyelectrochromic material 2 located centrally between these electrodes 3, 4 in a second color.

FIG. 4 illustrates the pixel 1 when a slightly higher positive potential, in comparison to that of FIG. 3, is applied to the electrode 3 for the same period of time while 0V is applied to the electrode 4, and 0V is applied to the counter-electrode 5. In this case the pixel 1 will be generated with a slightly larger part of its polyelectrochromic material 2 closest to the positively charged electrode 3 in the first color and the part of its polyelectrochromic material 2 located closest to the 0V electrode 4 in the second color.

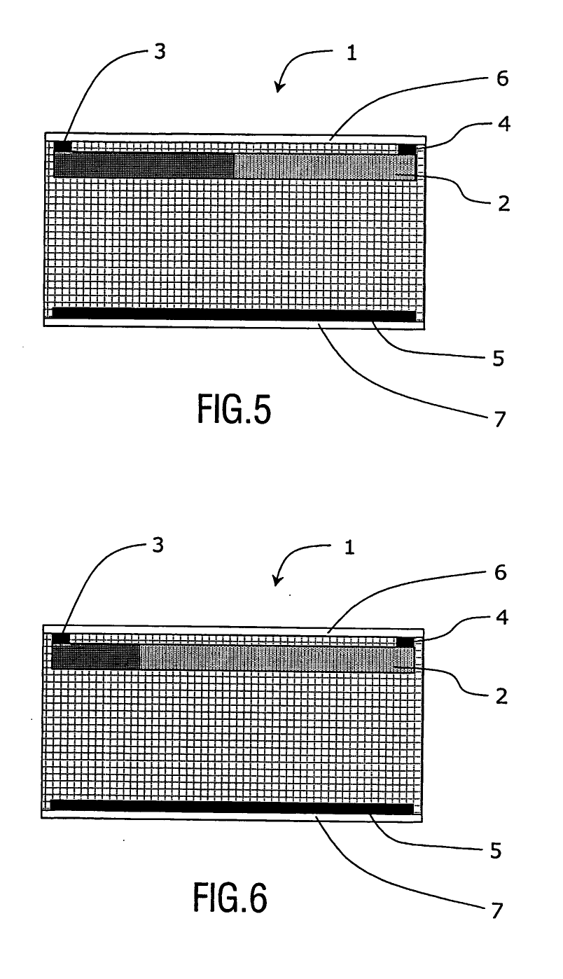

FIG. 5 illustrates the pixel 1 when a positive potential ranging between that of FIG. 3 and FIG. 4, is applied to the electrode 3 while 0V is applied to the electrode 4, and 0V is applied to the counter-electrode 5. In this case the pixel 1 will be generated with approximately half its polyelectrochromic material 2 closest to the positively charged electrode 3 in the first color and half of its polyelectrochromic material 2 located closest to the 0V electrode 4 in the second color.

FIG. 6 illustrates the pixel 1 when a moderate positive potential, like that of FIG. 2, is applied to the electrode 3 while 0V is applied to the electrode 4, and 0V is applied to the counter-electrode 5. In this case the pixel 1 will be generated with a small part of its polyelectrochromic material 2 closest to the positively charged electrode 3 in the first color and the rest of its polyelectrochromic material 2 located closest to the 0V electrode 4 in the second color. The state illustrated in FIG. 6 essentially correspond to the state illustrated in FIG. 1.

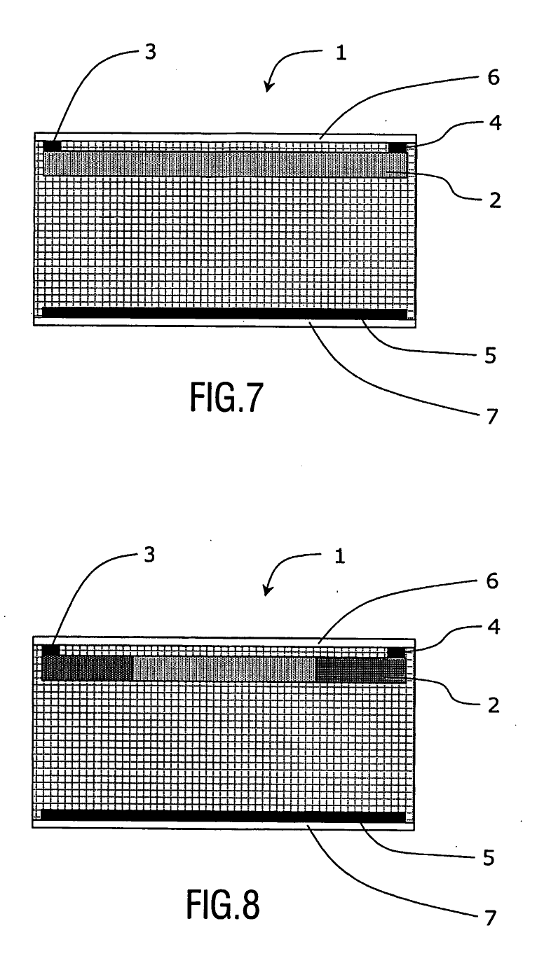

FIG. 7 illustrates the pixel 1 when 0V is applied to the electrodes 3 and 4, and a positive potential is applied to the counter-electrode 5. In this case the pixel 1 will be generated with all its polyelectrochromic material 2 in the second color. This state could also be used as a reset state.

As is evident from FIGS. 1 through 7, the use of several independently controllable electrodes in a pixel 1 of a display in accordance with the invention, facilitates the possibility of achieving generation of an analog color state in the pixel 1 through controlling the potentials applied to the respective electrodes 3, 4, 5 and the time of application to cause switching of an appropriate part of the polyelectrochromic material 2. By providing more than two electrodes in each pixel, the additional electrodes can be used to define more regions with defined colors in the pixel. In this manner it will also be possible to generate more than two colors within a single pixel. This is illustrated in FIG. 8, where, starting from a pixel reset to the state of FIG. 7, regions of two additional colors are generated around electrodes 3, 4 by applying 0V to counter-electrode 5, a moderate voltage to electrode 3 and a higher voltage to electrode 4, thus providing a color state with three separate color regions in the pixel.

When using an electronic display control device which comprises a microprocessor, a computer program product comprising software, code portions can be used for controlling the potentials applied in accordance with the invention for providing different color states to the pixels of the electrochromic display appliance when said computer program product is run on the micro-processor of the control device.

A method for generating analog color states in a pixel 1 of a display device having a first substrate 6; a second substrate 7; a polyelectrochromic material 2 disposed between said first substrate 6 and said second substrate 7, comprises the following steps: providing for at least two independent electrodes 3, 4 to be associated with said first substrate 6; providing for an independent counter-electrode 5 to be associated with said second substrate 7; providing for connection of each respective electrode 3, 4, 5 to an independently controllable voltage source; providing means for controlling the voltage applied to each respective electrode 3, 4, 5 for producing non-uniform electric fields in each pixel 1, for causing partial switching of the polyelectrochromic material 2 from a first color state to a second or further color state for generating an area ratio defined pixel color state. The method also allows for the step of providing means for controlling the time during which voltage is applied to each respective electrode 3, 4, 5. In order to facilitate switching between color states the method also suggests the steps of: providing memory storage means for storing a previously generated color state; providing means for comparing a color state to be achieved with a previously generated color state; providing means for determining the required potential to be applied to each respective electrode in order to reach a desired color state.

Thus, while there have been shown and described and pointed out fundamental novel features of the invention as applied to a preferred embodiment thereof, it will be understood that various omissions and substitutions and changes in the form and details of the devices illustrated and in their operation may be made by those skilled in the art without departing from the spirit of the invention. For example, it is expressly intended that all combinations of the elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A display device comprising a plurality of independently addressable pixels, wherein said pixels comprise: a first substrate; a second substrate; a polyelectrochromic material disposed between said first substrate and said second substrate; at least two independent electrodes associated with said first substrate; an independent counter-electrode associated with said second substrate; wherein each respective electrode is connected to an independently controllable voltage source; said display device having means for controlling the voltage applied to each respective electrode for producing non-uniform electric fields in each pixel, for causing partial switching of the polyelectrochromic material from a first color state to a second color state for generating an area ratio defined pixel color state.

2. The display device of claim 1, wherein said display device further has means for controlling the time during which voltage is applied to each respective electrode.

3. The display device of claim 1, wherein said display device further has means for controlling the voltage applied to each respective electrode of the pixel when in the second color state to cause a reset from the second color state to the first color state.

4. The display device of claim 1, wherein said display device further has memory storage means for storing a previously generated color state.

5. The display device of claim 4, wherein said display device further has means for comparing a color state to be achieved with a previously generated color state.

6. The display device of claim 5, wherein said display device further has means for determining the required potential to be applied to each respective electrode in order to reach a desired color state.

7. A method for generating analog color states in a pixel of a display device having a first substrate; a second substrate; a polyelectrochromic material disposed between said first substrate and said second substrate, comprising the steps of:
providing at least two independent electrodes to be associated with said first substrate;
providing an independent counter-electrode to be associated with said second substrate;
providing connection of each respective electrode to an independently controllable voltage source;
providing means for controlling the voltage applied to each respective electrode for producing non-uniform electric fields in each pixel, for causing partial switching of the polyelectrochromic material from a first color state to a second color state to generate an area ratio defined pixel color state.

8. The method of claim 7, further comprising the step of:
providing means for controlling the time during which voltage is applied to each respective electrode.

9. The method of claim 7, further comprising the steps of:
providing memory storage means for storing a previously generated color state;
providing means for comparing a color state to be achieved with a previously generated color state;
providing means for determining the required potential to be applied to each respective electrode in order to reach a desired color state.

10. A computer program product directly loadable into the internal memory of a digital computer comprising software code portions for performing the following steps when said product is run on a computer:
providing to at least two independent electrodes of an independently addressable pixel of an electrochromic display device a connection to an independently controllable voltage source;
providing control of the voltage applied to each respective electrode for producing non-uniform electric fields in each pixel;
providing control of the time during which voltage is applied to each respective electrode.

11. A computer program product stored on a computer readable storage medium, comprising computer readable program code means for causing a computer to perform the following steps:
providing to at least two independent electrodes of an independently addressable pixel of an electrochromic display device a connection to an independently controllable voltage source;
providing control of the voltage applied to each respective electrode for producing non-uniform electric fields in each pixel;
providing control of the time during which voltage is applied to each respective electrode.
